(19) United States
(12) Patent Application Publication
(10) Pub. No.: US 2025/0158435 A1
(43) Pub. Date: May 15, 2025

(54) METHOD AND SYSTEM FOR CONTROLLING VEHICLE BATTERY PACK BASED ON A BATTERY HEALTH MODEL DEFINED USING DATA-DRIVEN ANALYSIS

(71) Applicant: Ford Global Technologies, LLC, Dearborn, MI (US)

(72) Inventors: Xiaowu Zhang, Novi, MI (US); Shiping Shao, Canton, MI (US); Chen Zhang, South Lyon, MI (US); Ryan O'Gorman, Beverly Hills, MI (US); Soham Gupta, Mckinney, TX (US); Hossein Sartipizadeh, Centennial, CO (US)

(21) Appl. No.: 18/508,777

(22) Filed: Nov. 14, 2023

(51) Int. Cl. H02J 7/00; H02J 7/14

(52) U.S. Cl. CPC H02J 7/005; H02J 7/00032; H02J 7/0048; H02J 7/1446

(57) ABSTRACT

Controlling an electric vehicle having a battery pack includes, after a plurality of charging-discharging operations of the battery pack, controlling electric power usage of the battery pack based on a battery health measurement from a battery health model that uses a plurality of detected battery health inputs including a current life of the electric vehicle and an initial throughput characteristic.

### TECHNICAL FIELD

The present disclosure generally relates to managing a battery pack for an electric vehicle.

### BACKGROUND

An electric vehicle (EV) includes a battery pack, sometimes referred to as a traction battery, for providing power to electric motors to propel the EV. One or more operational characteristics of the battery pack may be monitored to assess a battery health (e.g., a state of health (SOH)) of the EV and/or control the operation of the battery pack.

### SUMMARY

A method for controlling an electric vehicle (EV) having a battery pack includes, after a plurality of charging-discharging operations of the battery pack, controlling electric power usage of the battery pack based on a battery health measurement from a battery health model that uses a plurality of detected battery health inputs including a current life of the EV and an initial throughput characteristic.

A system for controlling an electric vehicle having a battery pack includes one or more processors and one or more memory that store programming instructions executable by the one or more processors and that cause the one or more processors to, after a plurality of charging-discharging operations of the battery pack, control electric power usage of the battery pack based on a battery health measurement from a battery health model that uses a plurality of detected battery health inputs including a current life of the electric vehicle and an initial throughput characteristic.

A vehicle includes a battery pack and one or more processors that control electric power usage of the battery pack based on a battery health measurement from a battery health model that uses a plurality of detected battery health inputs including a current life of the vehicle and an initial throughput characteristic.

### BRIEF DESCRIPTION OF THE DRAWINGS

FIG. 1 illustrates a vehicle service server in communication with electric vehicles for providing battery health measurement for the electric vehicles in accordance with the present disclosure;

FIG. 2 is an example block diagram of an electric vehicle in accordance with the present disclosure;

FIG. 3 is a block diagram of a battery pack and a battery controller in accordance with the present disclosure; and

FIG. 4 is a flowchart of an example battery control routine in accordance with the present disclosure.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Estimating and monitoring the performance and health of a battery pack is generally employed to assess whether the battery pack, which can be the main source of power in the EV, is reliable, efficient, and capable of delivering power and energy when required. Battery health, which may be provided as a state of health (SOH), is a known metric used to control charging rate, estimate a state of charge (SOC), plan a route of the EV, and plan battery maintenance, among other tasks/operation involving the battery pack.

In one form, the present disclosure provides a vehicle battery health monitoring (VBHM) system employing a battery health model trained using simulation data and real-world data to estimate a battery health measurement in real time. More particularly, an EV is configured to provide battery health inputs to a vehicle service server, which in return estimates the battery health measurement using the battery health model. In some applications, the EV is configured to control operation of the battery pack based on the battery health model.

Among other features, the VBHM system provides a model that is scalable at the retail customer level to, for example, analyze multiple EVs having similar features together. The VBHM system further predicts/estimates the SOH in real-time, and/or provides a distributed computing platform to support SOH assessment, thereby removing the computational load from the EV and making the battery health model accessible to various EVs.

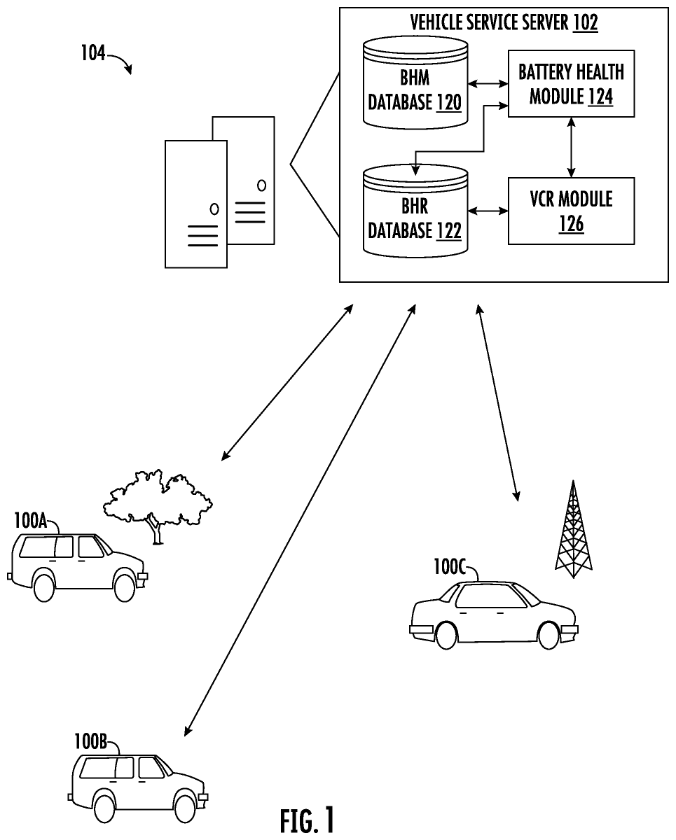

Referring to FIG. 1, one or more EVs 100A, 100B, 100C (collectively “EV 100”) are in communication with a vehicle service server 102 that is a cloud-based server remote from the EV 100. As described in detail herein, the vehicle service server 102 detects the battery health measurement of the EVs 100 using battery health models and battery health inputs from the respective EV 100. In some variations, the vehicle service server 102 may further provide a vehicle control recommendation to the respective EV 100 based on the battery health measurement. In one form, an EV 100 from the EVs 100 and the vehicle service server 102 form a VBHM system 104 for the EV 100.

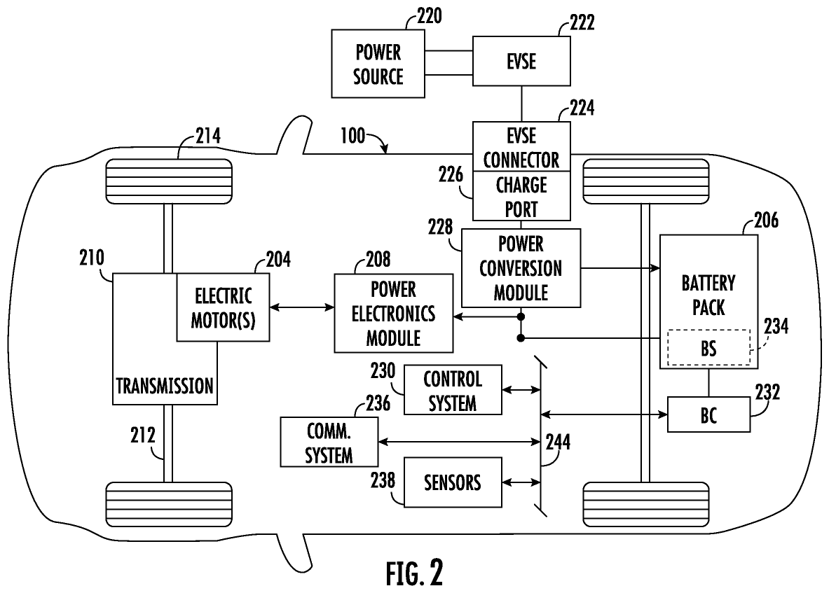

In one form, the EV 100 is provided as a battery electric vehicle (BEV) powered by electric motors. In a non-limiting example, referring to FIG. 2, the EV 100 includes a powertrain system having one or more electric motors 204 (i.e., electric machines), a battery pack 206 (i.e., a traction battery), and a power electronics module 208. The EV 100 of the present disclosure does not include an engine, and thus, the battery pack 206 provides all of the propulsion power. In other variations, the present disclosure may be applied to other types of EVs such as a plug-in hybrid electric vehicle (PHEV) having an engine, and is not limited to pure EVs.

The electric motor 204 provides power movement of the EV 100, and in a non-limiting example, is mechanically connected to a transmission 210 that is mechanically connected to a drive shaft 212, which is mechanically connected to wheels 214 of the EV 100. In addition to providing propulsion power, the electric motor 204 may be configured to operate as a generator to recover energy that may normally be lost as heat in a friction braking system of EV 100.

The battery pack 206 provides a high-voltage (HV) direct current (DC) output that is employed to power the electric motor 204 via the power electronics module 208. In one form, the power electronics module 208, which may include an inverter, provides a bi-directionally transfer energy between the battery pack 206 and the electric motor 204. Specifically, as known, the power electronics module 208 converts the DC voltage to a three-phase AC current to operate the electric motor 204, and in a regenerative mode, the power electronics module 208 converts three-phase AC current from the electric motor 204, which is acting as a generator, to DC voltage compatible with the battery pack 206.

The battery pack 206 is rechargeable by an external power source 220 (e.g., the grid), which is electrically connected to an electric vehicle supply equipment (EVSE) 222. EVSE 222 provides circuitry and controls to control and manage the transfer of electrical energy between external power source 220 and EV 100. External power source 220 may provide DC or AC electric power to EVSE 222. EVSE 222 may have a charge connector 224 for plugging into a charge port 226 of EV 100.

The EV 100 may further include a power conversion module 228 that is an on-board charger having a DC/DC converter to condition power supplied from the EVSE 222 and provide the proper voltage and current levels to the battery pack 206. The power conversion module 228 may interface with EVSE 222 to coordinate the delivery of power to the battery pack 206.

In addition to providing electrical energy for propulsion, the battery pack 206 may provide electrical energy for use by other electrical systems in the EV 100 such as HV loads like electric heater and air-conditioner systems, and low-voltage (LV) loads like an auxiliary battery. In addition, the battery pack 206 is configured to have bidirectional power transfer capability to provide power to systems outside of the EV 100 (i.e., external system) such as, but not limited to, home, business, and/or a microgrid. In a non-limiting example, the battery pack 206 is electrically coupled to the external system using the EVSE connector 224 and is operable to provide energy based on a transient load recommended for the external system and an amount of energy available from the battery pack 206.

In one form, the EV 100 includes a control system 230, which may also be referred to as a “vehicle controller,” to coordinate the operation of the various components. The control system 230 includes electronics, software, or both, to perform the necessary control functions for operating the EV 100. The control system 230 may be a combination vehicle control system and powertrain control module (VSC/PCM). Although the control system 230 is shown as a single device, the control system 230 may include multiple controllers in the form of multiple hardware devices, or multiple software controllers with one or more hardware devices. In this regard, a reference to a “controller” herein may refer to one or more controllers.

In one form, the EV 100 includes a battery controller (BC) 232 configured to monitor one or more operating characteristics of the battery pack 206 and, using known techniques, control operation of the battery pack 206 (e.g., manage the charging/discharging of the battery pack 206) based on, at least, the operating characteristics. The BC 232 is in communication with one or more battery sensors (BS) 234 provided in the battery pack 206 to detect at least some of the operating characteristics. As detailed below, the BC 232 is also configured to obtain battery health inputs and monitor the health of the battery pack 206 by requesting a battery health measurement based on the battery health inputs from the vehicle service server 102.

The EV 100 includes other devices/systems for performing other tasks outside of propelling the EV 100. In a non-limiting example, the EV 100 includes a communication system 236 configured to communicate with devices/servers external of the EV 100, such as the vehicle service server 102, using wireless communication established using cellular communication, WI-FI, BLUETOOTH, and/or among other communication techniques. Accordingly, among other components, the communication system 240 includes at least one of a telematics control unit configured to establish vehicle-to-everything (V2X) communication, global navigation satellite system (GNSS), and/or BLUETOOTH module having a BLUEETOOTH transceiver.

The EV 100 also includes one or more sensors 238 throughout the EV 100 to detect various characteristics in and/or around the EV 100. In a non-limiting example, the sensors 242 includes one or more temperature sensors that detect the temperature in a cabin of the EV 100 and an outside temperature (i.e., an external environment temperature).

The control system 230, the BC 232, the communication system 236, the sensors 238, and other devices/controllers/modules in the EV 100 communicate information to one another via a vehicle network 244. In a non-limiting example, the vehicle network 244 may be a wired network such as a controlled area network (CAN), or a wireless communication network.

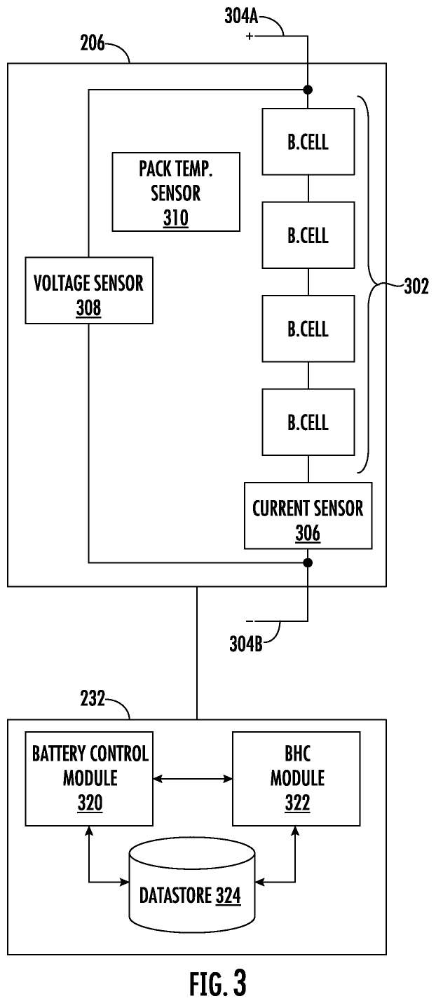

Referring to FIG. 3, the battery pack 206 includes a plurality of battery cells 302 that are electrically coupled to each other and to a positive power bus 304A and a negative power bus 304B (collectively “power buses 304”). While four battery cells 302 are illustrates, the battery pack 206 may include 2 or more battery cells 302. In addition, while that battery cells 302 are depicted as being arranged in series, the battery cells 302 may be connected in series, parallel, or a combination thereof.

In one form, the battery sensors 234 is in communication with the BC 232 to provide data indicative of electrical characteristic (voltage and/or current) and/or temperature. In a non-limiting example, the battery sensors 234 include a current sensor 306, a voltage sensor 308, and a pack temperature (temp.) sensor 310. The current sensor 306 is configured to detect a current being outputted from (i.e., discharged) or inputted to (i.e., charged) the battery pack 206. The voltage sensor 308 is configured to detect a terminal voltage of the battery pack 206. The pack temperature sensor 310 (e.g., a thermistor) is configured to detect a temperature of the battery pack 206, and while one temperature sensor 310 is provided multiple temperature sensors may be used.

In one form, the BC 232 is configured to control operation of the battery pack 206 and perform a battery health check (BHC), and includes a battery control module 320 and a BHC module 322. In one form, the battery control module 320 is configured to detect and monitor operation characteristics of the battery pack 206 using known defined algorithms and data from the battery sensors 234 and other devices, such as but not limited to, the control system 230 which provides desired outputs of the electric motors 204. In a non-limiting example, operating characteristics of the battery pack 206 includes: a charge capacity, a state-of-charge (SOC) of battery pack 206, throughput (i.e., power capability), and/or temperature of the battery pack 206. In one form, the battery control module 320 is configured to store data regarding the operation characteristics to a datastore 324.

The charge capacity of battery pack 206 is indicative of the maximum amount of electrical energy that the battery pack 206 may store. The SOC of battery pack 206 is indicative of a present amount of electrical charge stored in the battery pack 206. The SOC of battery pack 206 may be represented as a percentage of the charge capacity, which may be stored by the BC 232.

The throughput of the battery pack 206 is a measure of the total amount of energy that can be charged/discharged through the life of the battery pack 206, and may be measured in ampere-hour (Ah). As such, the throughput of the battery pack 206 corresponds to discharge and charge power limits which define the amount of electrical power that may be supplied by or supplied to the battery pack 206 at a given time.

In one form, the battery control module 320 provides one or more of the operation characteristics to the control system 230, so that the control system 230 knows how much power the battery pack 206 may provide (discharge) or take in (charge). Accordingly, the control system 230 operates, for example, the powertrain to meet performance demands of the user. The battery control module 320 may also provide the operation characteristics to other systems that may draw power from or provide power to the battery pack 206.

The BHC module 322 is configured to detect and monitor a battery health measurement of the battery pack 206. More specifically, the BHC module 322 is configured to obtain BHC inputs and request a battery health measurement from the vehicle service server 102 based on the BHC inputs. In one form, the BHC inputs includes an initial throughput characteristic, a vehicle life measurement, throughput characteristic, a previous state of health (SOH) measurement, and an average ambient temperature for a selected time period associated with the plurality of charging-discharging operations, and a delta throughput characteristic for the selected time period. In some variations, the BHC inputs may include other data such as, but not limited to, a temperature of the battery pack 206.

The initial throughput characteristic is the original or, stated differently, first throughput characteristic measurement defined at the time the EV 100 is manufactured and may be stored by the BHC module 322. The throughput characteristics is the throughput of the battery pack 206 and is indicative of an amp-power through the battery pack 206 and is routinely measured after multiple charging-discharging operations during a selected time period.

The vehicle life measurement is indicative of a present life of the EV 100, which may be provided using at least one of a mileage and/or numerical age.

The average ambient temperature is an average of temperature measurement of the external environment taken during a selected time period. That is, the temperature in which the EV 100 travels and thus, operates may affect the battery health. For example, cold temperatures may increase an internal resistance of the battery cells, and thus, reduce electric current capacity of the battery pack 206, whereas hot can reduce efficiency of chemical reactions within the battery cells 302.

In addition to the battery health inputs, the BHC module 322 may provide other information to the vehicle service server 102, such as but not limited to: a vehicle identification (e.g., a vehicle identification number, make/model of the vehicle, model year of the vehicle), and a time stamp.

In operation, the BHC module 322 is configured to monitor the vehicle life, which may be provided by the control system 230, and the number of charging/discharging operations being performed which is provided by the battery control module 320. After a selected time period, which may be associated with a selected number of charging/discharging operations to be performed, a selected accumulated milage (e.g., 100 miles, 500 miles, etc.), and/or selected duration (e.g., weekly), the BHC module obtains the BHC inputs, and forwards a request for the battery health measurement to the vehicle service server 102 via the communication system 230.

As described herein, the vehicle service server 102 determines the battery health measurement and provides the battery health measurement and, if applicable, a suggested control operation of the battery pack 206. Once received, the BHC module 322 stores the battery health measurement, and the battery control module 320 is configured to control operation of the battery pack 206 based on the battery health measurement or, if applicable, the suggested control operation.

Referring to FIG. 1, the vehicle service server 102 is configured to include a battery health model (BHM) database 120, a battery health record (BHR) database 122, a battery health module 124, and a vehicle control recommendation (VCR) module 126. The vehicle service server 102 may include other modules/controllers, such as but not limited to a known communication system for establishing communication with the EVs 100.

The BHM database 122 is configured to store a plurality of battery health models employed by the battery health module 124 to determine a battery health measurement for a requesting EV 100. In one form, a battery health model provides a battery health measurement using the battery health inputs and the initial throughput characteristic for the requesting EV 100. In one form, the battery health measurement provides as a change in SOH (i.e., delta SOH) that is indicative of a present electric current capacity over an initial (first measured) electric current capacity.

In one form, the battery health model is defined using a physics based model and a regression based machine learning algorithm to map the battery health inputs (e.g., the initial throughput characteristic, the vehicle life measurement, the throughput characteristic, the previous SOH measurement, and the average ambient temperature, among others) to the delta SOH as the output. More particularly, in a non-limiting example, the physics based model is trained simulation data and real-world data from various EVs. Various regression based machine learning platforms may be employed, such as but not limited to, XGBoost-type models. Accordingly, in lieu of purely mathematical algorithms, the battery health models provide a data driven approach for estimating the battery health measurement, which may be provided as a battery health measurement.

In some variations, the BHM database 122 stores a battery health model for different types of EVs such that the battery health model for the EVs 100A and 100B is different from the EV 100C since the EVs 100A and 100B are SUVs and has different performance demands than that of EV 100C, which is a sedan. In addition, the BHM database 122 may store a battery health model for different operation states of the battery pack 206, and/or the EV 100. In a non-limiting example, the operating states may include a drive state, a charge state, and a soak state in which the battery pack 206 is substantially at the external environment temperature. Each of these states may have a different effect on the battery heath. In some applications in which the battery pack 206 is operably to provide bidirectional power transfer, a battery health model may be trained to using measurement of the health inputs that reflect the battery pack 206 being discharged to charge an external system (e.g., a home or microgrid), which may have a different effect on the battery health than discharging the battery pack 206 to provide power to, for example, an in-vehicle system. Accordingly, the battery health inputs from the EV 100 may indicate the operating state of the EV 100 with respect to the battery health inputs.

The BHR database 122 is configured to store EV records associated with the EVs 100 that request the battery health measurement. In a non-limiting example, the EV records may include: a vehicle identification (e.g., vehicle identification number, make/model of the EV); an initial throughput characteristic of the EV 100; battery health model identification indicative of filename of one or more battery health models employed for the EV 100; calculation history including battery health inputs from the EV and the estimated battery health measurement, and, if applicable, the suggested control operation for the EV 100.

The battery health module 124 is configured to estimate the battery health measurement for the requesting EV 100. Specifically, the battery health module 124 receives a message from the requesting EV 100, where the message includes information such as, but not limited, to a vehicle identification and the battery health inputs. Using the information received, the battery health module 124 obtains the EV record associated with the EV 100 from the BHR database 122 and selects a battery health model from the BHM database 120. The battery health module 124 then estimates the delta SOH using the battery health inputs.

In one form, the VCR module 126 is configured to provide a suggested operation control for the battery pack 206 based on, at least, the battery health measurement estimated by the battery health module 124. In a non-limiting example, the VCR module 126 is configured to define a plurality of conditional controls that determine if the estimated delta SOH is within a nominal range, and if not, provide recommendations that are designed to reduce that rate of degradation of the SOH, where such recommendations are developed via experimentation, analysis of the real-life data to identify trends/relationship between one or more battery health inputs and the delta SOH. For example, if multiple fast-charge operation within a shorten period of time is identified to increase the rate at which the battery pack 206 degrades, the VCR module 126 is configured to implement the suggested operation control, which includes limiting DC charge rate for a fast charging operation.

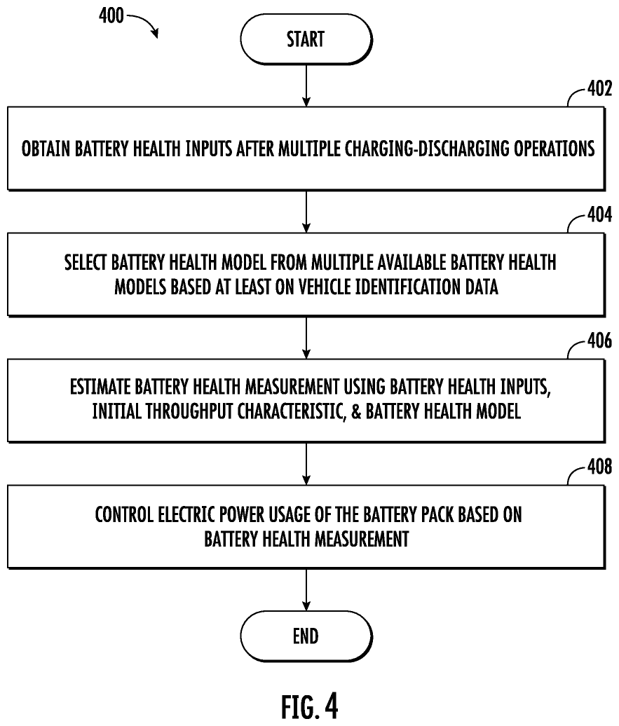

Referring to FIG. 4, a battery control routine 400 performed by the VBHM system 104 is provided. At operation 402, the system 104 obtains battery health inputs after multiple charging-discharging operations of the EV 100 of the system 104. In one form, the battery health inputs include the vehicle life, the throughput characteristic, a previous SOH measurement, an average ambient temperature for a selected time period associated with the plurality of charging-discharging operations, and a delta throughput characteristic for the selected time period. At operation 404, the system 104 selects a battery health model from multiple available battery health models based, at least, on a vehicle identification data associated with the EV 100. Other information may be used for selecting the battery health model, such as, but not limited to an operation state associated with that battery health inputs. At operation 406, the system 104 is configured to estimate a battery health measurement using the battery health inputs, initial throughput characteristic, and the selected battery health model. At operation 408, the system 104 is configured to control electric power usage of the battery pack 206 based on battery health measurement. More particularly, in a non-limiting example, the system 104 is configured to determine if the battery health measurement, which may be change (i.e., delta) SOH, is within a nominal threshold, and if it is not, the system 104 provides a suggested control operation of the battery pack 206.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

In this application, the term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The term memory or memory device is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A method for controlling an electric vehicle (EV) having a battery pack, comprising:
after a plurality of charging-discharging operations of the battery pack, controlling electric power usage of the battery pack based on a battery health measurement from a battery health model that uses a plurality of detected battery health inputs including a current life of the EV and an initial throughput characteristic.

2. The method of claim 1, wherein the plurality of detected battery health inputs further includes a previous state of health (SOH) measurement, an average ambient temperature for a selected time period associated with the plurality of charging-discharging operations, and a delta throughput characteristic for the selected time period.

3. The method of claim 1, wherein the battery health measurement is a delta SOH that is indicative of a present electric current capacity over an initial electric current capacity.

4. The method of claim 1, further comprising defining the battery health model employing a physics based model and regression based machine learning algorithms.

5. The method of claim 4, further comprising training the battery health model employing simulation data and real-world vehicle data.

6. The method of claim 1, further comprising selecting the battery health model from among a plurality of battery health models stored in a database based at least on vehicle identification data associated with the EV.

7. The method of claim 6, wherein the battery health model is further selected based on an operation state associated with that battery health inputs.

8. The method of claim 7, wherein the operation state includes at least one of a drive state of the EV, a charge state of the EV, and a soak state of the EV.

9. A system for controlling an electric vehicle having a battery pack, comprising:
one or more processors; and
one or more memory configured to store programming instructions executable by the one or more processors and configured to cause the one or more processors to, after a plurality of charging-discharging operations of the battery pack, control electric power usage of the battery pack based on a battery health measurement from a battery health model that uses a plurality of detected battery health inputs including a current life of the electric vehicle and an initial throughput characteristic.

10. The system of claim 9, wherein the plurality of detected battery health inputs further includes a previous state of health measurement, an average ambient temperature for a selected time period associated with the plurality of charging-discharging operations, and a delta throughput characteristic for the selected time period.

11. The system of claim 9, wherein the battery health measurement is a delta state of health that is indicative of a present electric current capacity over an initial electric current capacity.

12. The system of claim 9, wherein the programming instructions further cause the one or more processors to define the battery health model employing a physics based model and regression based machine learning algorithms.

13. The system of claim 12, wherein the programming instructions further cause the one or more processors to train the battery health model employing simulation data and real-world vehicle data.

14. The system of claim 9, wherein the programming instructions further cause the one or more processors to select the battery health model from among a plurality of battery health models stored in a database based at least on vehicle identification data associated with the electric vehicle.

15. The system of claim 14, wherein the battery health model is further selected based on an operation state associated with that battery health inputs.

16. The system of claim 15, wherein the operation state includes at least one of a drive state of the electric vehicle, a charge state of the electric vehicle, and a soak state of the electric vehicle.

17. The system of claim 9, further comprising a plurality of sensors arranged at the electric vehicle to detect at least one of an electrical characteristic of the battery pack and an external environment temperature about the electric vehicle, wherein the plurality of detected battery health inputs is detected based on the at least one of electrical characteristic of the battery pack and an external environment temperature about the electric vehicle.

18. A vehicle comprising:
a battery pack; and
one or more processors programmed to control electric power usage of the battery pack based on a battery health measurement from a battery health model that uses a plurality of detected battery health inputs including a current life of the vehicle and an initial throughput characteristic.

19. The vehicle of claim 18, wherein the plurality of detected battery health inputs further includes a previous state of health measurement, an average ambient temperature for a selected time period associated with a plurality of charging-discharging operations, and a delta throughput characteristic for the selected time period.

20. The vehicle of claim 18, further comprising a plurality of sensors to detect at least one of an electrical characteristic of the battery pack and an external environment temperature about the vehicle, wherein the plurality of detected battery health inputs is detected based on the at least one of electrical characteristic of the battery pack and an external environment temperature about the vehicle.
